(19) United States
(12) Patent Application Publication
(10) Pub. No.: US 2017/0150097 A1
(43) Pub. Date: May 25, 2017

(54) Communication System

(71) Applicant: Microsoft Technology Licensing, LLC, Redmond, WA (US)

(72) Inventors: Benjamin Gareth Dove, London (GB); Mohammed Ladha, Pinner (GB); Lee Christoper Pethers, Brentwood (GB); Sean R. Lailvaux, London (GB)

(73) Assignee: Microsoft Technology Licensing, LLC, Redmond, WA (US)

(21) Appl. No.: 15/355,902

(22) Filed: Nov. 18, 2016

(30) Foreign Application Priority Data
Nov. 20, 2015 (GB) 1520519.8

(51) Int. Cl. H04N 7/14; G06K 9/00; H04N 5/445; H04N 7/01

(52) U.S. Cl. CPC H04N 7/147; H04N 7/0122; G06K 9/00228; H04N 5/44591

(57) ABSTRACT

There is provided a method comprising: transmitting, from a user terminal configured to control a display to a network entity, a request to receive visual data associated with a user on a call; receiving, at a user terminal from the network entity, an indication of the visual data; selecting a first area of the display in which to render the visual data in dependence on the aspect ratio of the indicated visual data; and rendering, by the user terminal, at least part of the indicated visual data in the first area of the display so that the at least part of the indicated visual data extends to the edges of the first area.

### PRIORITY APPLICATIONS

This application claims priority under 35 USC 119 or 365 to Great Britain Application No. 1520519.8 filed Nov. 20, 2015, the disclosure of which is hereby incorporated by reference in its entirety.

### FIELD OF THE INVENTION

The present invention relates to a method, an apparatus and a method.

### BACKGROUND

A conversation visualisation environment is an environment operating on a device that causes graphical content associated with an exchange between users to be rendered on a display to one of the users performing the exchange. The exchange and the conversation visualisation environment result from the execution of code relating to a communication protocol. Conversation visualisation environments allow conversation participants to exchange communications in accordance with a variety of conversation modalities. For example, participants may engage in video exchanges, voice calls, instant messaging, white board presentations, and desktop views of other modes.

As the feasibility of exchanging conversation communications by way of a variety of conversation modalities has increased, so too have the technologies with which participants may engage in a video call using traditional desktop or laptop computers, tablets, phablets, mobile phones, gaming systems, dedicated conversation systems, or any other suitable communication device. Different architectures can be employed to deliver conversation visualisation environments, including centrally managed and peer-to-peer architectures.

Many conversation visualisation environments provide features that are dynamically enabled or otherwise triggered in response to various events. For example, emphasis may be placed on one particular participant or another in a gallery of video participants based on which participant is speaking at any given time. Other features give participants notice of incoming communications, such as a pop-up bubble alerting a participant to a new chat message, video call, or voice call.

### SUMMARY

During a video call, the conversation visualisation environment may render visual data (such as a dynamic-image data or static-image data) associated with a user on the display screen so as to indicate the presence of the user on the call. The visual data is representative of its respective user. For example, if Alice is talking to Bob and Charlie on a video call, the conversation visualisation environment may cause real-time (or near real-time) videos produced by Bob and Charlie's respective user terminals to be rendered on a display screen controlled by Alice's user equipment.

The inventors have realised that these videos are usually received and displayed in the same format. For example, a landscape orientated video having a particular height and width may be received for Bob whilst a portrait orientated video may be received for Charlie. Each user may be accorded the same screen space on Alice's display, normally resulting in the superposition of a border around at least part of the video to fill up the remainder space. This situation is illustrated with respect to FIG. 3.

FIG. 3 illustrates Alice's display 301, which is caused to render video data from Bob and video data from Charlie. As mentioned above, Bob has a landscape orientated video whilst Charlie has a portrait orientated video. Both Charlie and Bob are accorded respective equal spaces 302, 303 on Alice's display 301. To accommodate this, and the difference in height and width of each video, Alice's display 301 is caused to render solid colour fills (such as black lines) 304 around each of the videos.

The inventors have realised that such an arrangement may be an inefficient use of space on a display screen.

Accordingly, according to a first aspect, there is provided a method comprising: transmitting, from a user terminal configured to control a display to a network entity, a request to receive visual data associated with a user on a call; receiving, at a user terminal from the network entity, an indication of the visual data; selecting a first area of the display in which to render the visual data in dependence on the aspect ratio of the indicated visual data; and rendering, by the user terminal, at least part of the indicated visual data in the first area of the display so that the at least part of the indicated visual data extends to the edges of the first area.

According to a second aspect, there is provided a user terminal comprising: at least one processor; and at least one memory comprising code that, when executed on the at least one processor, causes the user terminal to: transmit, to a network entity, a request to receive visual data associated with a user on a call; receive, from the network entity, an indication of the visual data; select a first area of the display in which to render the visual data in dependence on the aspect ratio of the indicated visual data; and render at least part of the indicated visual data in the first area of the display so that the at least part of the indicated visual data extends to the edges of the first area.

According to a third aspect, there is provided a method comprising: receiving, at network entity from a user terminal configured to control a display, a request for a subscription to visual data associated with a user participating, or to participate in a call, wherein the request includes an indication of an area on the display in which the visual data is to be rendered; selecting an aspect ratio size of the visual data in dependence on the indication of the area on the display in which the visual data is to be rendered; and transmitting at least an indication of the selected visual data to the user terminal.

### FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user terminal;

FIG. 3 is a schematic illustration of a display screen;

FIG. 4 is a flowchart illustrating actions caused by a user terminal;

FIG. 5 is a flowchart illustrating actions caused by a network entity; and

FIG. 6 is a schematic illustration of a display screen.

### DESCRIPTION

The present application is directed towards utilising the area of a display screen efficiently. In particular, the present application is directed towards efficiently utilising a space on a screen that is used to display visual data associated with users participating in a multi-user call in a conversation visualisation environment. To this effect, the present application describes dynamically selecting at least a layout (also referred to herein as a configuration) of visual data rendered on the screen controlled by a user terminal. The present application further discloses the manipulation of the rendered visual data for the efficient use of space.

To enable this effect, the following discloses a user terminal configured to control a rendering of visual data on an associated display. The user terminal comprises at least one processor and at least one memory comprising computer code. When executed on the at least one processor, the computer code causes the user terminal to present a conversation visualisation environment relating to a multi-user call and to perform the actions described below (with relation to the user terminal). The conversation visualisation environment defines a window on the associated display that can be used for rendering visual data associated with a multi-user call.

The user terminal may be caused to transmit, to a network entity, a request to receive visual data associated with at least one user on a call. The request may be a request for a subscription to a stream of video data that is representative of at least one user on the call.

The call may be a multi-user call. In other words, the user terminal may receive information regarding the phone call from multiple (i.e. two or more) other user terminals. The information regarding the phone call may be coordinated by a centralised server (hereinafter known as the network entity), through which all external communications relating to the call are sent. The user terminal may send a subscription request to the network entity to indicate the streams of data it wishes to receive for the call. For example, the user terminal may request a subscription to receive video data for only some users on a multi-user call. For simplicity, the following will only refer to the case of a multi-user call, but it is understood that similar techniques may be applied when the user terminal is in a call with only one other user terminal.

The user terminal may be further caused to receive, from the network entity, an incoming stream of data for the multi-user call. Aside from the audio information that accompanies the call, the incoming stream comprises at least an indication of visual data associated with respective users on the call. In this case, an indication of visual data may comprise dynamic image data (e.g. video data or a gif), static image data and/or an indication that the user on the call does not have an associated image. In this latter case, the conversation visualisation environment may select an icon and/or a text-based graphical representation of an identity of the user to display in place of visual data. For example, in a video call between Alice, Bob and Charlie, Alice's device may receive video data for Bob and an indication that Charlie does not have an associated image for Charlie. Alice's user terminal may then select an image to render on the display for representing Charlie. The image may be retrieved from a library stored at the device. The image may be selected from those items labelled with labels such as “Charlie” or the like (for example, a locally designated profile photo for Charlie), or be selected randomly. The received respective video data for Bob and the selected image for Charlie may be used by Alice's device to render the respective visual data on Alice's display, to indicate that Charlie and Bob are currently participating in the call.

The incoming stream does not necessarily comprise image data (or an indication thereof) for every user on the call (although, as per the example mentioned above, it may). Instead, it may be that the user terminal is configured to receive the associated image data of only a subset of users on the call. The user terminal may achieve this by only subscribing to receive image data for particular users on the multi-user call. The subscription could be made to and/or coordinated by a central network entity, as described further below. Image data is considered to be visual data pertaining to an image, rather than to a solely text-based string.

The user terminal may be further caused to select a first area of the display in which to render the visual data in dependence on properties of the received indication of visual data. In particular, the user terminal may select a height and width (and/or an aspect ratio) of the first area in dependence on properties of the indicated visual data, such as the aspect ratio of the indicated visual data. The received indication and/or visual data may have different properties associated therewith. For example, the visual data to be rendered may have a certain aspect ratio, may comprise an identifiable object (such as a face), may have a certain resolution, may be associated with an activity level of the user represented the visual information, etc. Based on at least one property of the received indication of visual information, the user terminal may determine and/or select the first area of the display in which to render the visual data. In a particular embodiment, the user terminal is caused to select a first area of the display in which to render the visual data in dependence on the aspect ratio of the indicated visual data. For example, if the incoming visual data (or indicated visual data) is in a portrait format, the user terminal may cause the received visual data to be rendered in a portrait format on the display. If the incoming visual data (or indicated visual data) is in a landscape format, the user terminal may cause the received visual data to be rendered in a landscape format on the display.

It is also the case that other properties associated with the rendering of the visual data may be used to determine and/or select the first area of the display in which to render the visual data. For example, as mentioned above, the orientation (e.g. portrait or landscape) of the display on which the visual data is to be rendered may affect the selection of the first area of the display. Also, the type of device on which the visual data may be rendered (e.g. mobile or desktop-based) may affect the selection of the first area. For example, for mobiles, video data may take up a smaller relative space on the display relative to the desktop case, to reduce the amount of bandwidth used.

The type of connection (wide area network or local area network, associated charges, etc.) over which the user terminal is receiving the visual data may also influence the selection of the first area.

Further, the size of the available area on the device in which to render all of the visual data associated with the call may determine the selection of the first area. For example, the visual data used to represent a user may have an associated minimum size, which is the minimum area to be used for rendering on a display. If the visual data associated with that user is to be rendered and the total available area is only a little bigger than this minimum area, then visual data for only one user will be displayed and the size of the first area is consequently defined. If visual data associated with that user is to be rendered, and the total available area is at least double the minimum size, then the visual data associated with at least two users is to be rendered. The minimum size may be preprogrammed into the logic of the conversation visualisation environment, may be settable by a user, and/or be indicated with the visual data by the network entity.

As a default, the selection may be configured to split the total available space for rendering image data relating to a call equally between the number of users with whom the user of the user terminal is communicating on the call. The number of users having rendered image data may reduce in dependence on the minimum size (as discussed above). Further, the default may be overcome through other selections (e.g. user preference, size and/or aspect ratio of incoming visual data, etc.). For example, the user may select one particular image data to fill the available window.

The selection and/or determination of the first area may cause the layout/configuration of other visual data associated with other users on the multi-user call to be altered. For example, visual data may be rendered by the user terminal in the first area of the display so that at least part of the visual data extends to the edges of the first area. Hereinafter, the term “first respective visual data” is also used to denote this visual data rendered in the first area of the display. The user terminal may be further caused to render a second respective visual data in a second area of the display so that at least part of the second respective visual data extends to the edges of the second area, the first and second areas sharing a common edge. As the first and second areas share a common edge, and the rendered visual data is given a total area to fill by the conversational visualisation environment, changes to the layout/configuration of one of the rendered visual information affects the layout/configuration of the other rendered visual information. Further, as the rendered visual data fills the first and second areas, sharing a common edge, there is no need to colour-fill around parts of the rendered visual data. This means that the area of the display screen may be used efficiently.

The code on the user terminal may further comprise logic that causes the visual data to be reformatted and/or modified (e.g. changing the aspect ratio) for rendering the visual data on the display screen. This is detailed further below.

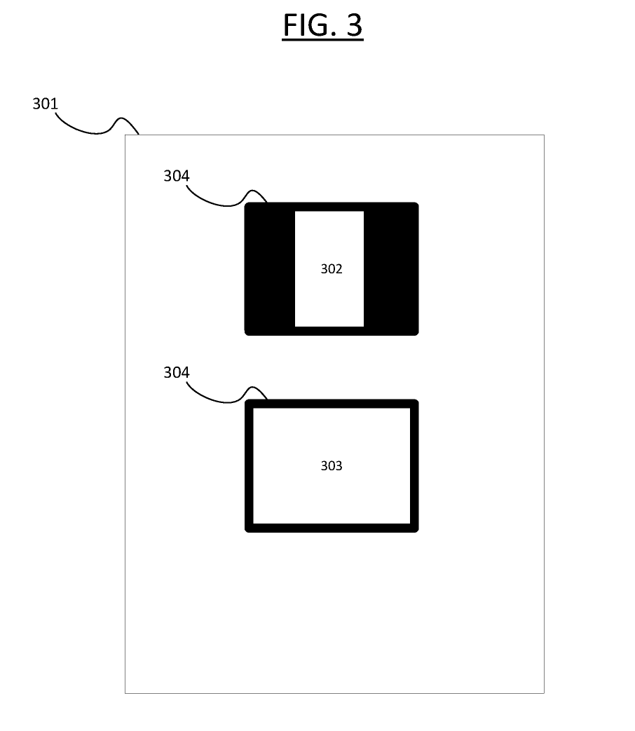

By the user terminal (via the code executing on the at least one processor) selecting/determining an area of a display in dependence on a property of the data actually received (instead of merely requested), the rendering of the visual data (e.g. video data) on the screen may be made more efficient. Further as the received visual data may fill the entirety of the available space allocated to it by the conversation visualisation environment, the display space is used efficiently. It is understood that although the visual data may fill the available space, other image data may also be superposed over that visual data. However, it is not necessary to surround the rendered visual data with at least part of a border to fill up unused space, as per the system described with reference to FIG. 3.

In order that the environment in which the present system may operate be understood, by way of example only, we describe a potential communication system and user equipment into which the subject-matter of the present application may be put into effect. It is understood that the exact layout of this network is not limiting.

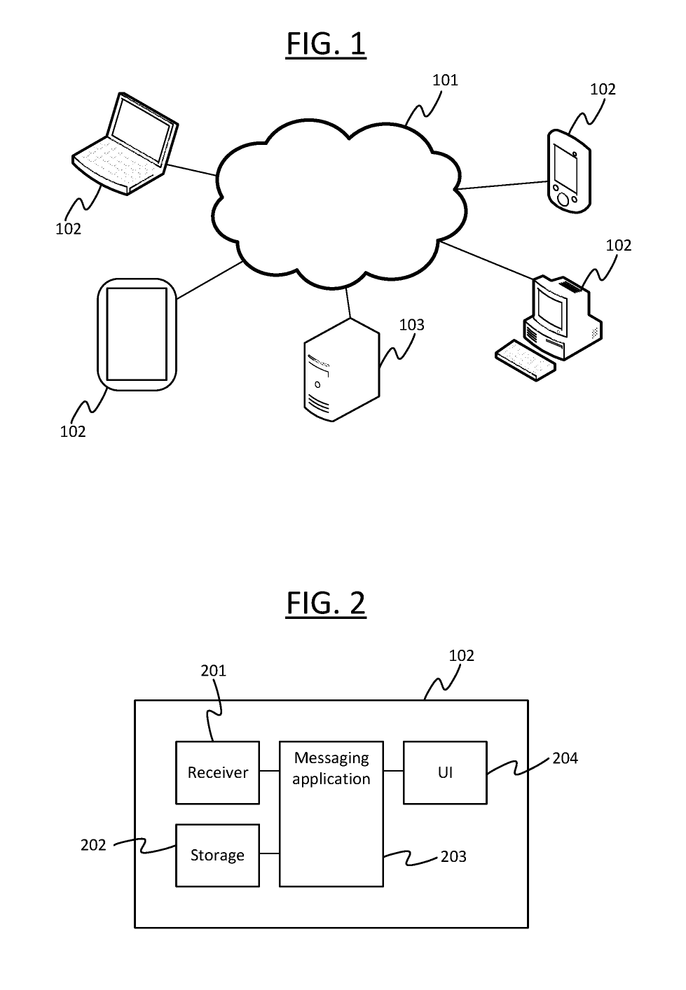

FIG. 1 shows an example of a communication system in which the teachings of the present disclosure may be implemented. The system comprises a communication medium 101, in embodiments a communication network such as a packet-based network, for example comprising the Internet and/or a mobile cellular network (e.g. 3GPP network). The system further comprises a plurality of user terminals 102, each operable to connect to the network 101 via a wired and/or wireless connection. For example, each of the user terminals may comprise a smartphone, tablet, laptop computer or desktop computer. In embodiments, the system also comprises a network apparatus 103 connected to the network 101. It is understood, however, that a network apparatus may not be used in certain circumstances, such as some peer-to-peer real-time communication protocols. The term network apparatus as used herein refers to a logical network apparatus, which may comprise one or more physical network apparatus units at one or more physical sites (i.e. the network apparatus 103 may or may not be distributed over multiple different geographic locations).

FIG. 2 shows an example of one of the user terminals 102 in accordance with embodiments disclosed herein. The user terminal 102 comprises a receiver 201 for receiving data from one or more others of the user terminals 102 over the communication medium 101, e.g. a network interface such as a wired or wireless modem for receiving data over the Internet or a 3GPP network. The user terminal 102 also comprises a non-volatile storage 202, i.e. non-volatile memory, comprising one or more internal or external non-volatile storage devices such as one or more hard-drives and/or one or more EEPROMs (sometimes also called flash memory). Further, the user terminal comprises a user interface 204 comprising at least one output to the user, e.g. a display such as a screen, and/or an audio output such as a speaker or headphone socket. The user interface 204 will typically also comprise at least one user input allowing a user to control the user terminal 102, for example a touch-screen, keyboard and/or mouse input.

Furthermore, the user terminal 102 comprises a messaging application 203, which is configured to receive messages from a complementary instance of the messaging application on another of the user terminals 102, or the network apparatus 103 (in which cases the messages may originate from a sending user terminal sending the messages via the network apparatus 103, and/or may originate from the network apparatus 103).

The messaging application is configured to receive the messages over the network 101 (or more generally the communication medium) via the receiver 201, and to store the received messages in the storage 202. For the purpose of the following discussion, the described user terminal 102 will be considered as the receiving (destination) user terminal, receiving the messages from one or more other, sending ones of the user terminals 102. Further, any of the following may be considered to be the entity immediately communicating with the receiver: as a router, a hub or some other type of access node located within the network 101. It will also be appreciated that the messaging application 203 receiving user terminal 102 may also be able to send messages in the other direction to the complementary instances of the application on the sending user terminals and/or network apparatus 103 (e.g. as part of the same conversation), also over the network 101 or other such communication medium.

The messaging application may transmit audio and/or visual data using any one of a variety of communication protocols/codecs. For example, audio data may be streamed over a network using a protocol known Real-time Transport Protocol, RTP (as detailed in RFC 1889), which is an end-to-end protocol for streaming media. Control data associated with that may be formatted using a protocol known as Real-time Transport Control Protocol, RTCP (as detailed in RFC 3550). Session between different apparatuses may be set up using a protocol such as the Session Initiation Protocol, SIP.

The following discusses a particular embodiment of the presently described system. It is understood that various modifications may be made within this embodiment without exceeding the scope of the claimed invention.

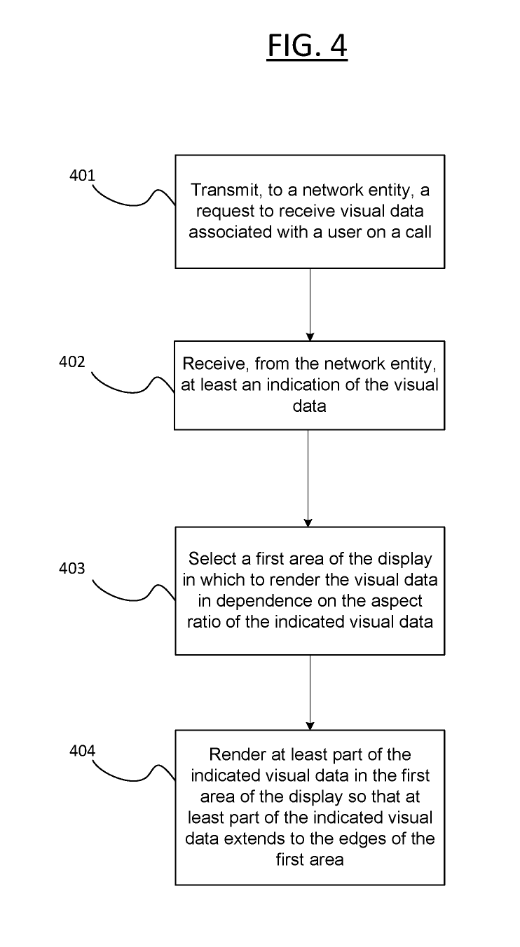

The following, described in relation to the flow chart of FIG. 4, illustrates possible actions executed by the user terminal on execution of the above-mentioned code.

There is provided a user terminal having an associated display for displaying (or otherwise presenting) graphical items to a user viewing the display. In this context, the phrase “associated display” relates to a display that the user terminal is able to control, at least in part, for rendering (i.e. presenting or otherwise displaying) data on the display. The user of the user terminal is usually the same as the user viewing the display output. In some cases, the display is integrated with the user terminal.

The user terminal is provided with computer code, stored in memory, that can be executed on at least one processor accessible to the user terminal to allow the user of the user terminal to participate in a call. The call is an audio-visual call, in which there is presented visual data (particularly, image data) via the display in addition to audio data. The audio data may be output by the user terminal via a speaker that the user terminal may control.

At 401, the user terminal is configured to transmit, to a network entity, a request to receive visual data associated with a user on a multi-user call. The request may relate to any user connected to, or attempting to connect to, the multi-user call. The request may comprise an indication of an area on the display in which said visual data is to be rendered. For example, where the request relates to visual data associated with a first user on the multi-user call, the request may comprise an indication of a first area of the display screen. Where the request relates to visual data associated with a second user on the multi-user call (the second user corresponds to a different user account to the first user), the request may comprise an indication of a second area of the display screen. The request may comprise an indication of the total available area of the display for rendering visual data in the conversation visualisation environment. In this case, the network entity may be further provided with an indication of the number of subscriptions for visual data for the multi-user call that are active. The indication of the area of the display screen (whether to the entire area afforded to the conversation by the conversation visualisation environment or to the area for the first visual data alone) may comprise at least one of: the height and width of the area; and/or the aspect ratio of the area of the display screen. The indication may also indicate a requested resolution of data. The requested resolution may be take a binary form (e.g. “high priority” or “low priority”), or specify one of a range of discrete values, or simply indicate the resolution relative to what is currently being received.

Where an indication is provided of an intended area in which to render the visual data, in dependence on the indication received by the network entity, the network entity may select visual data to send to the user terminal. In particular, the network entity may select visual data that is the closest in size to the requested visual information. In the alternate and/or in addition, the network entity may select visual data that is larger than the requested visual data, so that the user terminal may pare the visual data down at the user terminal. As mentioned above, the user terminal does not have to receive an indication of visual data for every user on the multi-user call (although they may do). Instead, the user terminal may subscribe to the network entity to receive indications of visual data for only some of the users on the multi-user call. This may help reduce the amount of congestion on the communication network (between the network entity and the user terminal).

At 402, the user terminal receives, from the network entity, at least an indication of the visual data. The user terminal therefore receives an incoming stream of data relating to a multi-user call. The indication of the visual data is received in response to the request for visual data. The indication may be at least one of: dynamic-image data (such as video data); static image data; and/or an indication of an image to use that uniquely identifies a user within a call. The visual data is respectively associated with at least one user of said multi-users, such that the visual data may be used to represent a particular one of said multi-users within the call. For example, the received at least one indication may be at least one of: an indication of an icon to use as an avatar for a user during the multi-user call; static image data for use as an avatar for a user during the multi-user call; an indication that the user terminal should select a static image from a library accessible to the user terminal; and dynamic image data (e.g. video data and/or gif data). The received indications relate to users associated with user terminals that are remote from the described user terminal. It is understood that similar techniques to those described herein may also be applied to those remote user terminals.

At 403, the user terminal is configured to select a first area of the display in which to render the visual data in dependence on the aspect ratio of the indicated visual data. In other words, the user terminal is configured to select the height and width (and/or aspect ratio) of the first area in dependence on the aspect ratio of the indicated visual data.

The received indication and/or visual data may have a variety of different properties associated therewith. For example, the visual data to be rendered may have a certain aspect ratio, may comprise an identifiable object (such as a face), may have a certain resolution, may be associated with an activity level of the user represented the visual information, etc. These are all examples of different properties associated with the visual data. Based on at least one property of the received indication of visual information, the user terminal may determine and/or select the first area of the display in which to render the visual data. In one embodiment, the first area is selected in dependence on the aspect ratio of the received incoming data, the area of the display afforded by the conversation visualisation environment for rendering all of the received visual information relating to the multi-user call and the number of users on the call for whom visual information is to be rendered.

It is also the case that other properties associated with the rendering of the visual data may be used to determine and/or select the first area of the display in which to render the visual data. For example, the orientation (e.g. portrait or landscape) of the display on which the visual data is to be rendered may affect the selection of the first area of the display. Also, the type of device on which the visual data may be rendered (e.g. mobile or desktop-based) may affect the selection of the first area. For example, for mobiles, video data may take up a smaller relative space on the display relative to the desktop case, to reduce the amount of bandwidth used. The type of connection (wide area network or local area network, associated charges, etc.) over which the user terminal is receiving the visual data may also influence the selection of the first area.

This selection and/or determination may cause the layout/configuration of other visual data associated with other users on the call to be altered. For example, visual data may be rendered by the user terminal in the first area of the display so that at least part of the visual data extends to the edges of the first area. Hereinafter, the term “first respective visual data” is also used to denote this visual data rendered in the first area of the display.

At 404, the user terminal is configured to cause the display to render at least part of the visual data in the first area of the display so that the at least part of the visual data extends to the edges of the first area. The first respective visual data is visual data associated with one of the users on the multi-user call that is connecting to the multi-user call via a remote user terminal.

In this way, the user terminal is configured to dynamically react to properties of the visual data that is to be rendered by the user terminal on the display, which may result in a more efficient use of the space of the display and in an improved rendering of the visual data.

The user terminal may be further caused to render a second respective visual data in a second area of the display so that at least part of the second respective visual data extends to the edges of the second area, the first and second areas sharing a common edge. As the first and second areas share a common edge, and the rendered visual information is given a total area to fill by the conversational visualisation environment, changes to the layout/configuration of one of the rendered visual information affects the layout/configuration of the other rendered visual information.

As it relates to the second respective visual data, the user terminal may be configured to transmit, to the network entity, a request to receive second respective visual data associated with a second user on the multi-user call, the request comprising another indication of an area on the display in which said second respective visual data is to be rendered. In response to this request, the user terminal receives, from the network entity, an indication of the second respective visual data, the second respective visual data having a size that is dependent on the area of the display in which said other visual data is to be rendered. The user terminal may then select (and subsequently render in) a second area of the display for rendering the second respective visual data, so that at least part of the second respective visual data extends to the edges of the second area, the first and second areas sharing a common edge.

Such a technique may also apply in respect of third respective visual data, which is visual data representative of a third user on the multi-user call. After selecting a third area of the display in dependence on the received third respective visual data, the user terminal is configured to render, on the display, the third respective visual data in a third area of the display so that at least part of the third respective visual data extends to the edges of the third area, the first and second areas sharing respective common edges with the third area.

As mentioned above, the user terminal may be further configured to cause a second area of the display to render a second respective visual data in a second area of the display so that at least part of the second respective visual data extends to the edges of the second area. The second respective visual data is visual data associated with another one of the users on the multi-user call that is connecting to the multi-user call via another remote user terminal. The first visual data is therefore different to the second visual data. The visual data corresponds to the at least an indication of visual data received in the incoming data stream. The first and second areas are mutually exclusive areas. The first area is immediately adjacent to the second area. The first and second areas share at least one common edge.

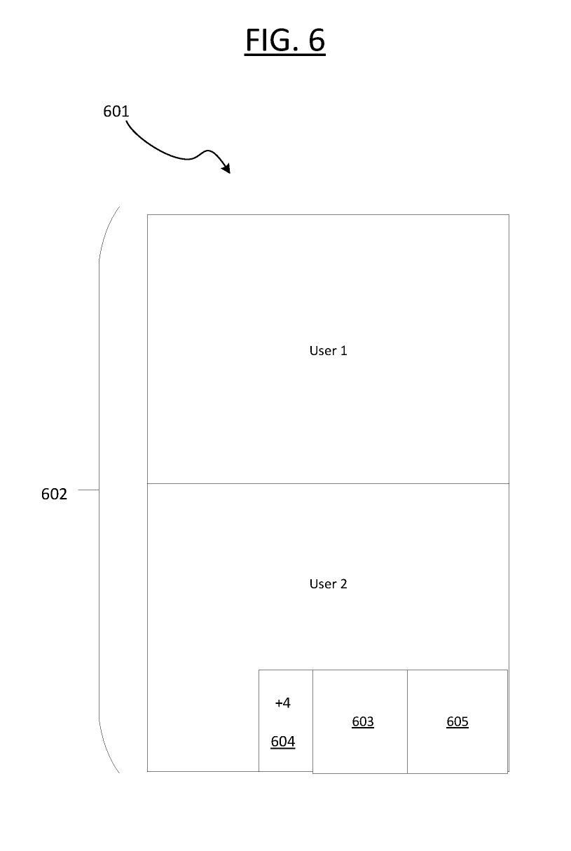

An example rendering of visual data in a conversation visualisation environment presented on a display is illustrated with respect to FIG. 6.

FIG. 6 displays a conversation visualisation environment 601. The conversation visualisation environment may be caused to be rendered on a screen controlled by a user terminal as a result of code executing on at least one processor to which the user terminal has executable access.

Within the conversation visualisation environment 601, there is a primary area 602 that is configured to display video data associated with user 1 and user 2 on a multi-user phone call. Within the conversation visualisation environment 601, there is further a secondary area 603 that is configured to display video data of user 3. The resolution of the video data of user 3 is smaller than that of the resolution of the video data of user 1 and user 2, as the size of the secondary area 603 is much less than the size of the primary area 602 allocated to each of user 1 and user 2.

Immediately adjacent to the secondary area 603, there is a tertiary area 604 in which a summary of the other users on the multi-user call is rendered. In the example of FIG. 6, the summary indicates that there are 4 more users on the multi-user call by displaying the graphical symbol “+4”. There is a final area 605 depicted, in which video data associated with the user using the user terminal is provided.

Rendering visual data in a first area of the display may further comprise: determining the size of the first area and the visual data; and cropping and/or altering an aspect ratio of the visual data in dependence on the determined sizes in order that the visual data extends to the edges of the first area.

The decision as to how to crop and/or alter the aspect ratio of the visual data may be made in dependence on a variety of factors.

For example, the decision may depend on a setting that limits a change in the aspect ratio of the received visual data does to no more than a threshold amount. For example, the computer code may limit the change in aspect ratio to no more than 10%. This mitigates the likelihood of an object within the visual data being rendered unrecognisable (or only partially recognisable), but may still allow for an object within the visual data to become a focus of the rendered visual information.

The decision may further depend on the detection of an object within the visual data. For example, the user terminal may apply facial recognition algorithms to the visual data in order to detect at least one face in the visual data. If a face (or at least one face) is detected, the user terminal may determine how to crop and/or alter the aspect ratio of the visual data in dependence on the detected face. For example, after receiving visual data for rendering on a display, the user terminal may run a face detection algorithm that detects a face in the visual data. The user terminal selects the face to act as a focus point in the visual data and crops the visual data around the face/focus point. The rendered visual data is thus only part of the received visual data, and is centred on the face.

As another example, the user terminal may determine how to crop and/or alter the aspect ratio of the visual data in dependence on the display orientation of the user terminal. In this context, the display orientation relates to the format of the area allocated by the conversation visualisation environment for rendering visual data associated with the multi-user call (also called the viewport ow window). For example, if the display is in a landscape orientation (e.g. the height is smaller than the width), then the visual data may be cropped for rendering on the display in the opposite configuration to the screen (e.g. so that it is cropped to have a portrait orientation). The opposite may also be performed (e.g. cropping visual data for rendering in a landscape format when the display is in a portrait orientation). Further, if the orientation of the display is changed during the multi-user call (for example, when rendered on a mobile device, the mobile device may be turned to its side), this will affect the determination and selection of the first (and/or second) area.

As another example, the user terminal may determine how to crop and/or alter the aspect ratio of the visual data in dependence on the orientation of the incoming visual data (e.g. landscape and/or portrait). This is a more specific case of making the determination in dependence on the height and width of the incoming visual data. Where video data is received from a remote user terminal, this may be seen as the angle field of view of the camera recording the video data for the remote user terminal. Changes to the field of view may affect the aspect ratio of the received visual data.

As another example, the user terminal may determine how to crop and/or alter the aspect ratio of the visual data in dependence on the number of users in the multi-user call for whom the associated visual data is video data. For example, the user terminal may be configured to display only visual data that is video data and/or to prioritise the display of video data over other types of visual data. The number of video data users may therefore define the number of area of the display rendering distinct video data associated with a respective user.

As another example, the user terminal may determine how to crop and/or alter the aspect ratio of the visual data in dependence on the number of active speakers on the call within a preceding time period. For example, if only two people out of four people on a multi-user call have spoken in the preceding 10 seconds (or some other predetermined time period), video data may be displayed for only those two people. This defines the area of the display that may be shared between the two active users (i.e. the users who have spoken within a predetermined time period). The split between the users may be equal or unequal and may be determined automatically by the user terminal in dependence on the above-mentioned properties of the visual data.

As another example, the user terminal may determine how to crop and/or alter the aspect ratio of the visual data in dependence on the type of user terminal used by a user on the call. For example, the requirements for a mobile device (such as a smart phone) may be different to a desktop-based device (such as a laptop and/or PC). This may reflect the different scripts and/or capabilities provided by the processing abilities of the different types of devices.

The user terminal may be further configured to cause the display to render a panned and/or zoomed view of at least one of the rendered visual content. This may be performed following receipt, by the user terminal, of a user input, instructing the user terminal to create and cause a zoomed and/or panned view to be displayed.

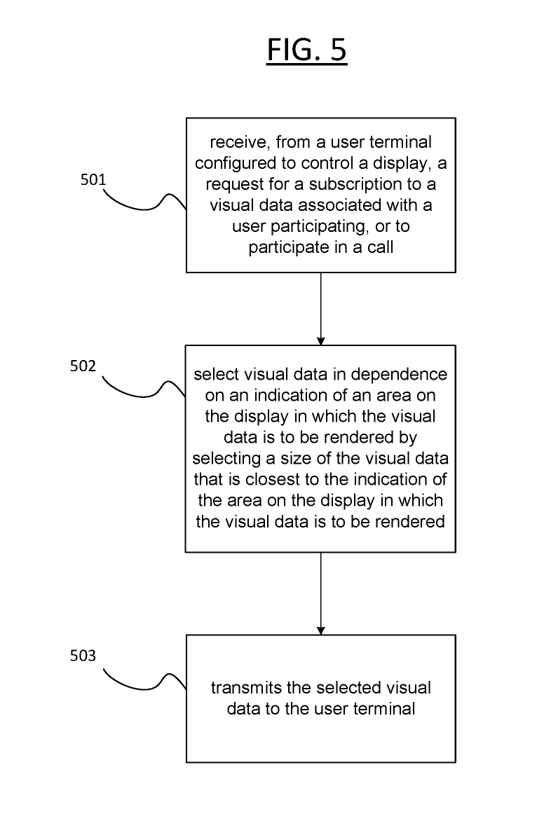

For completeness, the following describes, with reference to FIG. 5, possible actions undertaken by the network entity.

At 501, the network entity receives, from a user terminal configured to control a display, a request for a subscription to a visual data associated with a user participating in, or to participate in multi-user call. The request includes an indication of an area on the display in which the visual data is to be rendered.

At 502, the network entity selects visual data in dependence on the indication. The network entity may select the visual data in dependence on the indication by selecting a size of the visual data that is closest to the indication of the area on the display in which the visual data is to be rendered. In this context, the size may be a specific height and width and/or an aspect ratio of the visual data being selected.

At 503, the network entity transmits the selected visual data to the user terminal.

The above-described techniques have especial use in packet communication networks that use the Voice over Internet Protocol (VoIP), which is a set of protocols and methodologies for transmitting audio data over a communication medium. It is understood that other protocols may be used for this purpose without impacting on the above-described techniques.

The above-described techniques have especial use when the visual data is video data. The video data is real-time or near real-time. The user terminal may be configured to identify video data in the received indications of visual data and to determine to render video data as a priority over other forms of visual data. In other words, the user terminal may be configured to prioritise the rendering of video data over static image data.

According to the above, there is provided a method comprising: transmitting, from a user terminal configured to control a display to a network entity, a request to receive visual data associated with a user on a call; receiving, at a user terminal from the network entity, an indication of the visual data; selecting a first area of the display in which to render the visual data in dependence on the aspect ratio of the indicated visual data; and rendering, by the user terminal, at least part of the indicated visual data in the first area of the display so that the at least part of the indicated visual data extends to the edges of the first area.

Rendering visual data in a first area of the display may further comprise: determining the size of the first area and the size of the visual data; and cropping and/or altering an aspect ratio of the visual data in dependence on the determined sizes in order that the visual data extends to the edges of the first area.

The method may further comprise: determining to crop and/or alter the aspect ratio of the visual data so that the change in aspect ratio of the visual data does not exceed a threshold amount.

The method may further comprise: performing facial recognition analysis on the visual data for detecting whether or not there is at least one face in the visual data; and determining, in response to detecting at least one face in the visual data, to crop and/or alter the aspect ratio of the visual data to avoid cropping the detected at least one face.

The method may further comprise: determining a current orientation of the display; and determining to crop and/or alter the aspect ratio in dependence on the display orientation in order that the visual data extends to the edges of the first area.

The method may further comprise: determining the number of users in the multi-user call for whom the associated visual data is video data; and determining to crop and/or alter the aspect ratio in dependence on the number of users associated with video data.

The method may further comprise: determining the number of active speakers on the call within a preceding time period; and determining to crop and/or alter the aspect ratio in dependence on the determined number of active speakers.

The method may further comprise: determining a type of user terminal used by a user on the call; and determining to crop and/or alter the aspect ratio in dependence on the determined type of user terminal.

The method may further comprise: configuring the display to enable a user of the user device to zoom in and/or pan within at least one of the rendered visual content.

The method may further comprise: transmitting, from the user terminal to the network entity, a request to receive other visual data associated with another user on the multi-user call, the request comprising another indication of an area on the display in which said other visual data is to be rendered; receiving, at the user terminal from the network entity, an indication of the other visual data; selecting a second area of the display in which to render the other visual data in dependence on the aspect ratio of the indicated other visual data; and rendering, by the user terminal, the at least part of the indicated other visual data in a second area of the display so that the at least part of the indicated other visual data extends to the edges of the second area, the first and second areas sharing a common edge.

The method may further comprise: rendering, at the user terminal, a third visual data in a third area of the display so that at least part of the third visual data extends to the edges of the third area, the first and second areas sharing respective common edges with the third area.

Selecting the first area of the display in which to render the visual data in dependence on the received indication of visual data may comprise: further determining at least one property associated with the user and/or the indication of visual data; and selecting the first area in dependence on the determined at least one property. The at least one property may be at least one of: a detected face in the visual data; the number of users on the call for whom visual data is being rendered on the display; the resolution of the image; the orientation of the user terminal; and an activity level associated with the user.

There is further provided a user terminal comprising at least one processor and at least one memory comprising code that, when executed on the at least one processor, causes the user terminal to perform any of the above-mentioned methods.

There is further provided a user terminal comprising: at least one processor; and at least one memory comprising code that, when executed on the at least one processor, causes the user terminal to: transmit, to a network entity, a request to receive visual data associated with a user on a call; receive, from the network entity, an indication of the visual data; select a first area of the display in which to render the visual data in dependence on the aspect ratio of the indicated visual data; and render at least part of the indicated visual data in the first area of the display so that at the least part of the indicated visual data extends to the edges of the first area.

The user terminal may, to select the first area of the display in which to render the visual data in dependence on the received indication of visual data, be caused to: further determine at least one property associated with the user and/or the indication of visual data; and select the first area in dependence on the determined at least one property.

The at least one property may be at least one of: a detected face in the visual data; the number of users on the call for whom visual data is being rendered on the display; the resolution of the image; the orientation of the user terminal; and an activity level associated with the user.

There is further provided a method comprising: receiving, at network entity from a user terminal configured to control a display, a request for a subscription to visual data associated with a user participating, or to participate in a call, wherein the request includes an indication of an area on the display in which the visual data is to be rendered; selecting an aspect ratio size of the visual data in dependence on the indication of the area on the display in which the visual data is to be rendered; and transmitting the selected visual data to the user terminal.

The selected size may be selected from a set of possible aspect ratios and may be the closest in size, in that set, to the area on the display in which the visual data is to be rendered. The selected size may be selected from a set of possible aspect ratios and is the next largest in size, in that set, to the area on the display in which the visual data is to be rendered. Selecting the size may comprise selecting an aspect ratio of the visual data.

There is further provided a network apparatus comprising at least one processor and at least one memory comprising code that, when executed on the at least one processor, causes the user terminal to perform any of the above-mentioned methods.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
transmitting, from a user terminal configured to control a display to a network entity, a request to receive visual data associated with a user on a call;
receiving, at the user terminal from the network entity, an indication of the visual data;
selecting a first area of the display in which to render the visual data in dependence on the aspect ratio of the indicated visual data; and
rendering, by the user terminal, at least part of the indicated visual data in the first area of the display so that the at least part of the indicated visual data extends to the edges of the first area.

2. A method as claimed in claim 1, wherein rendering visual data in a first area of the display further comprises:
determining the size of the first area and the size of the visual data; and
cropping and/or altering an aspect ratio of the visual data in dependence on the determined sizes in order that the visual data extends to the edges of the first area.

3. A method as claimed in claim 2, further comprising:
determining to crop and/or alter the aspect ratio of the visual data so that the change in aspect ratio of the visual data does not exceed a threshold amount.

4. A method as claimed in claim 2, further comprising:
performing facial recognition analysis on the visual data for detecting whether or not there is at least one face in the visual data; and
determining, in response to detecting at least one face in the visual data, to crop and/or alter the aspect ratio of the visual data to avoid cropping the detected at least one face.

5. A method as claimed in claim 2, further comprising:
determining a current orientation of the display; and
determining to crop and/or alter the aspect ratio in dependence on the display orientation in order that the visual data extends to the edges of the first area.

6. A method as claimed in claim 2, further comprising:
determining the number of users in the multi-user call for whom the associated visual data is video data; and
determining to crop and/or alter the aspect ratio in dependence on the number of users associated with video data.

7. A method as claimed in claim 2, further comprising:
determining the number of active speakers on the call within a preceding time period; and
determining to crop and/or alter the aspect ratio in dependence on the determined number of active speakers.

8. A method as claimed in claim 2, further comprising:
determining a type of user terminal used by a user on the call; and
determining to crop and/or alter the aspect ratio in dependence on the determined type of user terminal.

9. A method as claimed in claim 1, further comprising:
configuring the display to enable a user of the user device to zoom in and/or pan within at least one of the rendered visual content.

10. A method as claimed in claim 1, further comprising:
transmitting, from the user terminal to the network entity, a request to receive other visual data associated with another user on the multi-user call;
receiving, at the user terminal from the network entity, an indication of the other visual data;
selecting a second area of the display in which to render the other visual data in dependence on the aspect ratio of the indicated other visual data; and
rendering, by the user terminal, at least part of the other visual data in the second area of the display so that the at least part of the other visual data extends to the edges of the second area, the first and second areas sharing a common edge.

11. A method as claimed in claim 10, further comprising:
rendering, at the user terminal, a third visual data in a third area of the display so that at least part of the third visual data extends to the edges of the third area, the first and second areas sharing respective common edges with the third area.

12. A method as claimed in claim 1, wherein selecting the first area of the display in which to render the visual data in dependence on the received indication of visual data comprises:
further determining at least one property associated with the user and/or the indication of visual data; and
selecting the first area in dependence on the determined at least one property.

13. A method as claimed in claim 12, wherein the at least one property is at least one of: a detected face in the visual data; the resolution of the image; the orientation of the user terminal; and an activity level associated with the user.

14. A user terminal comprising:
at least one processor; and
at least one memory comprising code that, when executed on the at least one processor, causes the user terminal to:
transmit, to a network entity, a request to receive visual data associated with a user on a call;
receive, from the network entity, an indication of the visual data;
select a first area of the display in which to render the indicated visual data in dependence on the aspect ratio of the indicated visual data; and
render at least part of the indicated visual data in the first area of the display so that the at least part of the indicated visual data extends to the edges of the first area.

15. A user terminal as claimed in claim 14, wherein to select the first area of the display in which to render the visual data in dependence on the received indication of visual data, the user terminal is caused to:
further determine at least one property associated with the user and/or the indication of visual data; and
select the first area in dependence on the determined at least one property.

16. A user terminal as claimed in claim 15, wherein the at least one property is at least one of: a detected face in the visual data; the number of users on the call for whom visual data is being rendered on the display; the resolution of the image; the orientation of the user terminal; and an activity level associated with the user.

17. A method comprising:
receiving, at network entity from a user terminal configured to control a display, a request for a subscription to visual data associated with a user participating, or to participate in a call, wherein the request includes an indication of an area on the display in which the visual data is to be rendered;
selecting an aspect ratio size of the visual data in dependence on the indication of the area on the display in which the visual data is to be rendered; and
transmitting at least an indication of the selected visual data to the user terminal.

18. A method as claimed in claim 17, wherein the selected size is selected from a set of possible aspect ratios and is the closest in size, in that set, to the area on the display in which the visual data is to be rendered.

19. A method as claimed in claim 17, wherein the selected size is selected from a set of possible aspect ratios and is the next largest in size, in that set, to the area on the display in which the visual data is to be rendered.

20. A method as claimed in claim 17, wherein selecting the size comprises selecting an aspect ratio of the visual data.
